(19) United States
(12) Patent Application Publication
(10) Pub. No.: US 2004/0243925 A1
(43) Pub. Date: Dec. 2, 2004

(54) Document management method and software product

(76) Inventors: Vernon Ronald Yates, Carindale (AU); Ian Douglas Yates, Annerley (AU)

Correspondence Address: Monique A. Morneault, Esq., Wallenstein Wagner & Rockey, Ltd., 53rd Floor, 311 South Wacker Drive, Chicago, IL, 60606-6630, US

(21) Appl. No.: 10/834,690

(22) Filed: Apr. 29, 2004

(30) Foreign Application Priority Data
May 30, 2003 (AU) 2003204440

(51) Int. Cl. G06F 17/30

(52) U.S. Cl. 715/500

(57) ABSTRACT

A method for managing documents by means of a computer system includes the steps of recording an expected return-time for each document issued to a party external to the computer system. In the event that the return of the document from the external party is not entered into the computer system by the expected return-time then the computer system issues an operator alert so that an operator may take steps to recover the document. In a preferred embodiment each document has associated with it a time dependent reliability parameter indicating a reliability time-frame. Documents issued outside the reliability time-frame are printed with a warning that the veracity of the data contained in the document is doubtful.

### FIELD OF THE INVENTION

The present invention relates to a method and software product for document management, tracking, storage and retrieval.

### BACKGROUND TO THE INVENTION

Since the widespread adoption of computerised word processing and data storage systems in the early 1980's there has been an explosion in the number of documents generated in business. For example, professional service businesses, such as law firms and doctor's practices generate and issue a multitude of forms and documents in their day-to-day operation.

In recent years the cost-to-capacity ratio of electronic storage devices, namely hard disk drives, has fallen exponentially. As a consequence, numerous document management systems, typically involving the storage of electronic versions of documents, have been developed.

For example, Optix Document Management Software by Imation Corp is an engineering document management software product for managing electronic information in a manner that facilitates the ready location and retrieval of documents. This is accomplished by providing functions such as information capture (receiving, processing, and managing electronic information in native file formats), document imaging (scanning, indexing, storing, and viewing) and document management (check-in/check-out, version control, and document handling).

Presently available document management systems are of assistance in categorising, storing and retrieving documents, and also in recording the identities of the persons to whom documents are issued. For example, a medical practitioner may make use of a presently available document management software product to assist in the storage and retrieval of patient notes and forms from a data storage facility. Medical practitioners and other professional service providers, frequently issue documents to patients for completion with personal details. Where the details are inserted immediately then the completed document may be entered into the document management system at once. However, in practice there are circumstances that can prevent the document form ever being returned for entry into the document management system, including it being lost or misplaced in its workflow. Should such circumstances arise then a problem may follow in that the completed document may not be returned for entry into the document management system. A further problem is that as documents age the information in them often becomes less and less likely to be reliable.

It is an object of the present invention to address the above problems.

### SUMMARY OF THE INVENTION

According to a first aspect of the present invention there is provided a method for managing documents including the steps of:

generating a document by means of a computer system for issue to parties external to the computer system;

associating an expected return-time with the document; and

generating an alert in the event that notification of the return of the document from the external parties is not entered into the computer system by the expected return-time.

Preferably the step of generating the document includes the computer system producing the document from a selected one of a number of document templates.

In a preferred embodiment the document includes a label for attachment to an externally generated document.

Preferably the expected return-time is obtained from a document template.

The step of generating the document may include generating the document with a machine-readable code.

For example, the machine-readable code may comprise a barcode.

In a preferred embodiment the machine-readable code is encoded with a unique document identifier.

Preferably the entry of the return of the document includes the reading of the machine-readable code by a peripheral device of the computer system.

The peripheral device may be a barcode reader.

Alternatively, the peripheral device may be a scanner providing output data to an optical character recognition software module.

The method may include the step of associating one or more time dependent reliability parameters with time sensitive documents stored in the computer system.

Preferably the method includes the step of producing copies of a time sensitive document with a message concerning the reliability of the information on the document on the basis of the time dependent reliability parameters.

The time dependent reliability parameters may include a parameter indicating a time frame during which the veracity of data contained in a stored document may be adjudged to be correct.

The time dependent reliability parameters may further include a parameter indicating a time frame during which the veracity of data contained in a stored document may be adjudged to be doubtful.

According to a further aspect of the present invention there is provided a computer software product including a computer readable medium for execution by one or more processors of a computer system, the software product containing instructions for implementing a method according to any one of the preceding claims.

Further features of the invention will be ascertained from the following description which will be made with reference to a number of drawings.

### BRIEF DESCRIPTION OF THE DRAWINGS

FIG. 1 is a schematic diagram depicting the components of a document management system according to a preferred embodiment of the present invention.

FIG. 2 is a flowchart of method for managing documents according to a preferred embodiment of the present invention.

### DETAILED DESCRIPTION OF EXEMPLARY EMBODIMENTS

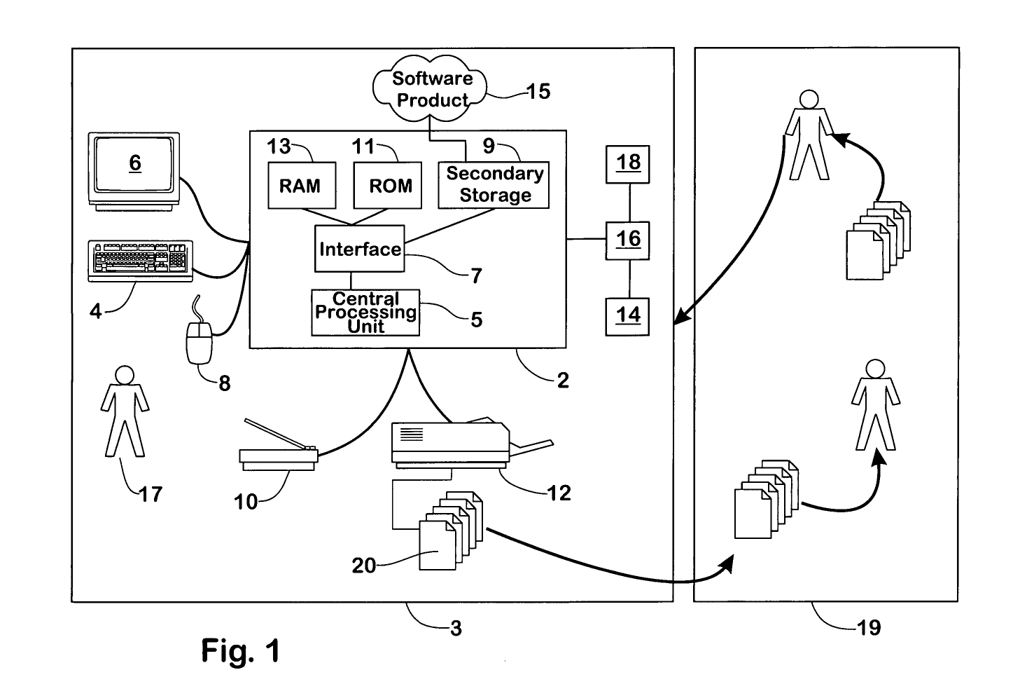

The present invention is primarily intended to be implemented on a conventional personal computer system 3 as shown in FIG. 1. It is intended that system 3 be used for managing documents associated with a professional service firm. System 3 includes a computer case 2 which houses a processor 5 (or one or more processors) that accesses RAM 13, ROM 11 and various secondary data storage devices 9 such as hard drives. The processor executes a software product 15 stored in data storage 15 that contains instructions for implementing a method according to the present invention. The software product is typically provided on an optical or magnetically readable medium such as a CD-ROM or floppy diskette, though it might also be provided in a ROM or other electronic circuit as firmware. The software product includes instructions for system 3 to implement a method that will be explained.

By means of conventional interfacing circuitry 7 located on a mainboard within case 2, the processor receives commands from input devices such as keyboard 4 and mouse 8. Processor 5 controls and communicates with a number of peripheral devices including a scanner 10, for converting documents into electronic file format and a printer 12, for converting electronic files into paper hardcopy 20. The paper hardcopy is issued to parties, for example clients of the firm, in external workflow 19. The processor in case 2 may communicate with remote computers 14 and 18 via a network support module 16 such as a LAN switch or VPN internet gateway.

Software product 15 includes instructions for the system, under control of processor 5, to generate and issue documents and to alert operator 17 of system 3 to the potential loss of those documents.

According to a preferred embodiment of the present invention the software product contains instructions for generating documents of at least two types as follows:

System Generated

System generated documents are produced from master templates each of which has version control, with any newly generated document always produced using the current version of the appropriate master template. Templates are collated into clusters which allow for a group of document types to be printed as a complete process with control provided for the quantity of each type of document that is produced for each event of generating, usually printing, a cluster. The document may include fields which solicit information from the client to whom it is issued. The information may be entered by hand or the document may be straight text and intended as an information piece. Metadata may be automatically merged with the content of the template. The generation process includes the assignment of a unique identifying code for each discrete document and the publishing process incorporates that identifying code as a machine readable object embedded into the document such as a printing process would produce a barcode. Where applicable the publishing process also produces the code in a format readable by humans.

Externally Generated

Externally generated documents are produced by processes external to the system. Often externally generated documents will be in hard-copy format. For example, a referral letter from a general medical practitioner to a medical specialist would be classified as an externally generated document. In order for hard copy documents to be entered into the system the software product contains instructions for printing a label using a template in the manner of a system-generated document. The templates used for print labels are collated into clusters in the same manner as the templates that produce system-generated documents.

It is also quite possible for externally generated documents to be in an electronic format such as an e-mail or word processor file. The software product contains instructions for processing electronic files in order to archive them for later retrieval. If required the electronic files may be converted into another format such as a TIFF image file or an Adobe Acrobat® PDF file.

No matter whether the documents are system generated or externally generated the software product contains instructions for issuing prompts for the entry of metadata about the document. The metadata is embedded into an index set pertaining to each of the documents to provide extended searching and retrieval capabilities. The meta-data typically includes fields identifying the author of the document, its version history, the name of the person to whom the document has been issued and the title of the document, for example. Also associated with each document is a unique document identifier number and a time parameter. The time parameter indicates if the document is to be tracked for loss in the external workflow and also if the veracity of its content is likely to be particularly sensitive to the passage of time. The time parameter may take one of three values as follows:

NN—Documents

Documents of this type are not tracked for loss in the external workflow and are also not tracked on the basis that they contain time sensitive data. The system does however register that the document was generated and includes in that registration the date, time and location of generation (typically printing) as well as the version of the template that was used to generate the document. Type NN documents can be recreated as exact replicas of the original using the stored metadata and the original version of the template.

TN—Documents

Documents of this type can include system provided metadata but are tracked for loss in the external workflow by monitoring the time elapsed from when they are created and issued. The time allowed for circulation in the external workflow, i.e. the expected return-time or “dwell” time is set for each individual document template so that different document types are allowed different dwell times.

The majority of forms for completion by clients typically fall into the TN category. Upon the elapsed time exceeding the predetermined dwell time, which is the latest expected time for the return of the document to the system, an alert is generated. The elapsed time counter is reset upon the document being returned to the system. Where forms are filled out by hand they are returned to the system by being scanned in.

Documents of type TN are uniquely identified by a machine-readable identifier such as a barcode, as well as human readable indicia placed on the form by the system at the time of generating (usually printing) the form. Accordingly, upon scanning in a TN type document the system is able to determine from the barcode the identity of the document and flag that the document has been returned from the external workflow.

TN documents are not tracked on the basis that they contain time sensitive data.

TT—Documents

Documents of this type are tracked for loss in the external workflow in the manner of TN documents. In addition they are also tracked for time sensitive data captured on the document. For example, a patient may fill out a form requesting data about the patient and the patient's family's medical status. It will be realised that the medical status on the form are time sensitive because they are likely to become incorrect with the passage of time. Accordingly, two distinct time parameters are associated with TT documents in addition to dwell time. The first of the additional parameters is a reliability period. From the time at which a document is returned for archiving to the end of the reliability period the document may be made available for printing and/or display without any system intervention or alert.

The second of the additional parameters is called the “doubtful” window which defines a period from the end of the reliability period during which the veracity of information on a document should be assumed to be in doubt. If a request is received to print a copy of a TT document during its doubtful window then the system will print it but with an added statement explaining the need to validate the information contained on the document. The document will also be printed with a field requesting that the person to whom the document is issued check and validate that the details contained on the form remain correct. Once validated the document automatically becomes a new version of the original with its time periods reset to run from the date of validation.

If a request is received to print a copy of a TT document that is outside both its reliability period and its doubtful window, then the system will generate the document but with a marking that the data it contains is unreliable.

The time at which a TN or TT document is generated and issued is recorded. For example, a doctor might issue a form requesting information about a patient's medical history. At the time that the form is generated the software product allocates a “dwell” time being the expected time that the document will stay with the patient or within its normal workflow before it is completed and returned for archiving in the system. In the event that the return of the document is not entered into the computer system within the allowed dwell time then the system will issue an alert identifying the document.

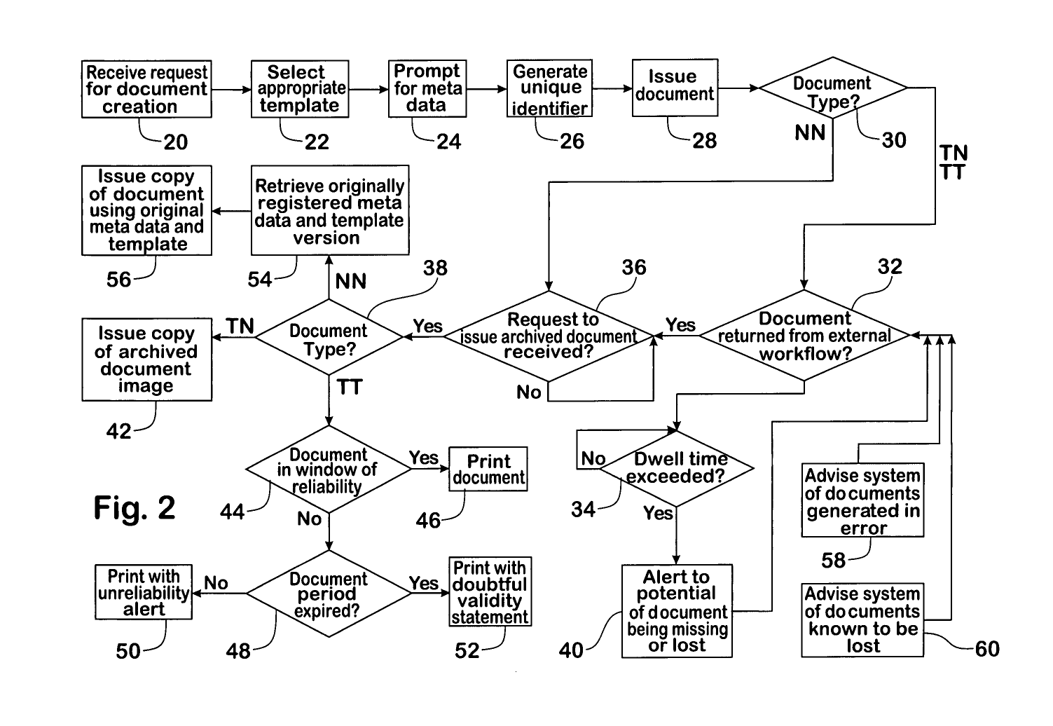

FIG. 2 is a flowchart illustrating the operation of system 3 under the control of software product 15. At box 20 the system receives a request for document creation. This will typically involve operator 17 entering a suitable command, by means of either keyboard 4 or mouse 8 that identifies the type of document to be created. At box 22 the appropriate template for the document creation is accessed from storage 9. The template contains data indicating the type of document to be created, either TT, TN or NN and the expected dwell time if applicable. At box 24 a request is displayed on screen 6 for the operator to input metadata to be associated with the document that is to be created. At box 26 a unique identifier is generated for the document. At box 28 the document is generated and printed in paper form 20 by printer 12. If the document that is issued is of type NN then at box 30 control diverts to box 36. Alternatively if the document that issued is of type TN or TT then the dwell time for the document will be monitored. In that case, at box 30 control diverts to box 32 and thence to box 34. At box 34 the system checks to determine if the dwell time associated with the document has been exceeded. If it has been exceeded then control diverts to box 40 and an alert is raised, for example on display 6, to draw operator 17's attention to that fact. The operator may then take steps to recover the document from the external workflow. If the operator is able to retrieve the document then it will be archived by converting it to electronic format with scanner 10.

If documents are produced in error the system allows for that fact to be registered and so account for both the document and its disposal. Similarly if the need for the document is withdrawn, for example in the case of a patient cancelling an appointment, then the system will allow for the accounting of the document's destruction and the reason for that destruction.

As previously mentioned, the document contains identification codes, for example barcoding of the unique identifier, so that the system is able to identify which document is being returned and to deactivate any expired dwell time flag that may be present for the particular document. After box 40 control passes back to box 32. At box 32 a check is performed to determine whether or not the document has returned from the external workflow. If it has returned from the external work flow then control diverts to box 36 until a request to issue an archived document is entered. In the event that the type of document that has been requested is of type NN then control passes to box 54 where a replica of the original document is assembled using metadata and template version data registered at the time of generating the original document and then passed to box 56 where a copy of the requested document is printed out. In the event that the type of document that has been requested is of type TN then control passes to box 42 and a copy of the requested document is printed out.

Alternatively, if the requested document is of type TT then control passes to box 44. If, at box 44 it is determined that the type TT document is within its reliable window then at box 46 the document is printed. Alternatively, if at box 44 it is determined that the requested document is outside of its reliability window then control diverts to box 48. If at box 48 it is determined that the document is within its doubtful period then at box 50 the document is printed out with an unreliability alert superimposed upon it. Alternatively, if the document is outside of its doubtful period then at box 52 it is printed with a statement that the information it contains is of doubtful validity superimposed upon it. Type TT documents that are reprinted for confirmation of validity may be scanned again into the system with the validated version of the original document now becoming the next generation or version of the original document.

The embodiments of the invention described herein are provided for purposes of explaining the principles thereof, and are not to be considered as limiting or restricting the invention since many modifications may be made by the exercise of skill in the art without departing from the scope of the following claims.

1. A method for managing documents including the steps of:
generating a document by means of a computer system for issue to parties external to the computer system;
associating an expected return-time with the document; and
generating an alert in the event that the return of the document from the external parties is not entered into the computer system by the expected return-time.

2. A method for managing documents according to claim 1, wherein the step of generating the document includes the computer system producing the document from a selected one of a number of document templates.

3. A method for managing documents according to claim 1, wherein the document comprises a label for attachment to an externally generated document.

4. A method for managing documents according to claim 2 wherein the expected return-time is obtained from a document template.

5. A method for managing documents according to claim 1, wherein the step of generating the document includes generating the document with a machine-readable code.

6. A method for managing documents according to claim 5, wherein the machine-readable code comprises a barcode.

7. A method for managing documents according to claim 5, wherein the machine-readable code is encoded with a unique document identifier.

8. A method for managing documents according to claim 5, wherein the entry of the return of the document includes the reading of the machine-readable code by a peripheral device of the computer system.

9. A method for managing documents according to claim 8, wherein the peripheral device is a barcode reader.

10. A method for managing documents according to claim 8, wherein the peripheral device is a scanner providing output data to an optical character recognition software module.

11. A method for managing documents according to claim 1 further including the step of associating one or more time dependent reliability parameters with time sensitive documents stored in the computer system.

12. A method for managing documents according to claim 11, including the step of producing copies of a time sensitive document with a message concerning the reliability of the information on the document on the basis of the time dependent reliability parameters.

13. A method for managing documents according to claim 11, wherein the time dependent reliability parameters include a parameter indicating a time frame during which the veracity of data contained in a stored document may be adjudged to be correct.

14. A method for managing documents according to claim 11, wherein the time dependent reliability parameters further include a parameter indicating a time frame during which the veracity of data contained in a stored document may be adjudged to be doubtful.

15. A computer software product including a computer readable medium for execution by one or more processors of a computer system, the software product including:
instructions for generating a document by means of the computer system for issue to parties external to the computer system;
instructions for associating an expected return-time with the document; and
instructions for generating an alert in the event that the return of the document from the external parties is not entered into the computer system by the expected return-time.

16. A computer software product according to claim 15, including instructions for the computer system to produce the document from a selected one of a number of document templates.

17. A computer software product according to claim 16, including instructions to generate the document in the form of a label.

18. A computer software product according to claim 16, including instructions to determine the expected return-time from a document template.

19. A computer software product according to claim 18, including instructions to generate the document with a machine-readable code.

20. A computer software product according to claim 19, including instructions to generate the machine-readable code in the form of a barcode.

21. A computer software product according to claim 15, including instructions to associate one or more time-dependent reliability parameters with time sensitive documents stored in the computer system.

22. A computer software product according to claim 21, including instructions to produce copies of a time sensitive document with a message concerning the reliability of the information on the document on the basis of the time dependent reliability parameters.

23. A computer software product including a computer readable medium for execution by one or more processors of a computer system, the software product including:
instructions to generate a document by means of the computer system with a machine readable code said document being for issue of parties external to the computer system;
instructions to associate an expected return-time with the document and to encode said return-time in the machine readable code; and
instructions to generate an alert in the event that the return of the document from the external parties is not entered into the computer system by the expected return-time.
